(19) United States
(12) Patent Application Publication
(10) Pub. No.: US 2010/0259273 A1
(43) Pub. Date: Oct. 14, 2010

(54) COLD CATHODE IONIZATION VACUUM GAUGE, VACUUM PROCESSING APPARATUS INCLUDING SAME AND DISCHARGE STARTING AUXILIARY ELECTRODE

(75) Inventors: Yohsuke Kawasaki, Yamanashi (JP); Toshio Kikuchi, Yamanashi (JP)

Correspondence Address: FITZPATRICK CELLA HARPER & SCINTO, 1290 Avenue of the Americas, NEW YORK, NY, 10104-3800, US

(73) Assignee: CANON ANELVA CORPORATION, Kawasaki-shi (JP)

(21) Appl. No.: 12/724,543

(22) Filed: Mar. 16, 2010

(30) Foreign Application Priority Data
Apr. 9, 2009 (JP) 2009-094942
Apr. 28, 2009 (JP) 2009-109097
Mar. 4, 2010 (JP) 2010-047685

(51) Int. Cl. G01L 21/34

(52) U.S. Cl. 324/460

(57) ABSTRACT

The present invention provides a cold cathode ionization vacuum gauge that can trigger discharge in a short time even in the case of use over a long period of time without needing a complicated apparatus. It has the structure in which a rod-like anode is located in an internal part of a measuring element container (cathode) having a discharge space with one end thereof which is sealed, and a discharge starting auxiliary electrode is mounted on this anode. The discharge starting auxiliary electrode triggers the discharge in a short time by the formation of a carbon nanotube layer on a discharge starting auxiliary electrode plate.

### CROSS-REFERENCES TO RELATED APPLICATIONS

This application claims the benefit of priorities from Japanese Patent Application No. 2009-094942 filed on Apr. 9, 2009, Japanese Patent Application No. 2009-109097 filed on Apr. 28, 2009 and Japanese Patent Application No. 2010-047685 filed on Mar. 4, 2010, the entire contents of which are incorporated herein by reference.

### BACKGROUND OF THE INVENTION

1. Field of the Invention

The present invention relates to a cold cathode ionization vacuum gauge, a vacuum processing apparatus including the cold cathode ionization vacuum gauge and a discharge starting auxiliary electrode. In particular, the present invention relates to a cold cathode ionization vacuum gauge using a discharge starting auxiliary electrode, vacuum processing apparatus including a discharge starting auxiliary electrode, and a discharge starting auxiliary electrode.

2. Description of the Related Art

A cold cathode ionization vacuum gauge triggers gas ionization by the self-discharge between an anode and a cathode to measure, for example, the gas pressure in a vacuum container, which forms a vacuum processing apparatus. There have been known cold cathode ionization vacuum gauges of many types: the penning, magnetron and inverted magnetron (refer to Japanese Patent Laid-Open Gazette No. H10-19711). In particular, the magnetron or inverted magnetron-types are structured to have high electron trapping efficiencies and to be able to make a stable self-sustaining discharge even in a high-level vacuum region, thus being suitable for measurement in high-level vacuum regions.

In a cold cathode ionization vacuum gauge, it is necessary to apply a high voltage to trigger the gas ionization for the purpose of starting the discharge. Generated delay will occur, however, between the timing at which a high voltage is applied to the cold cathode ionization vacuum gauge and the timing at which a discharge current begins to flow accompanied by the start of self-sustaining discharge. This time delay affects the time period before the start of measurement.

In an inverted magnetron-type cold cathode ionization vacuum gauge described in Japanese Patent Laid-Open Gazette No. H06-26967, by providing, at a cathode, a discharge triggering means of directly generating electromagnetic radiation sufficient to cause the cathode to emit photoelectrons, the discharge trigger time period from the application of a voltage to the start of self-sustaining discharge can be shortened.

In a cold cathode ionization vacuum gauge described in Japanese Patent Laid-Open Gazette No. H06-26967, since the gauge comprises a glow lamp or an ultraviolet irradiation lamp for triggering the discharge and circuits for this purpose, a problem exists in that such an apparatus evolves into complicated structures.

A magnetron or inverted magnetron-type cold cathode ionization vacuum gauge exhibits high trapping effects of charged particles so that the wall surface of the container of the gauge is likely to be sputtered. Therefore, in the case of use over a long period of time, sputtered films or products will stick to the lamp surface and thus the radiation of ultraviolet rays will be impaired. As a result, a problem exists in that the generation of photoelectrons which act to cause the start of discharge will be reduced and the discharge will be unlikely to be triggered.

### SUMMARY OF THE INVENTION

An object of the present invention provides a cold cathode ionization vacuum gauge, a vacuum processing apparatus including the cold cathode ionization vacuum gauge and a discharge starting auxiliary electrode which can trigger discharge in a short time even in the case of use over a long period of time without making the structures of the apparatus complicated.

The present invention provides a cold cathode ionization vacuum gauge comprising, an anode, a cathode disposed so as to form a discharge space together with the anode, and a discharge starting auxiliary electrode including a carbon nanotube layer and disposed in the discharge space and electrically connected to at least one of the anode and cathode.

According to the present invention, it becomes possible to trigger discharge in a short time without creating a complicated apparatus.

### BRIEF DESCRIPTION OF THE DRAWINGS

FIG. 1 is a schematic diagram illustrating a vacuum processing apparatus provided with a cold cathode ionization vacuum gauge according to a first embodiment of the present invention.

FIG. 2 is a traverse cross sectional diagram illustrating the cold cathode ionization vacuum gauge according to the first embodiment of the invention.

FIG. 3 is a cross sectional schematic diagram taken along the line F-F of FIG. 2.

FIG. 4 is an enlarged diagram of E portion of FIG. 2.

FIG. 5 is a diagram illustrating an application example using an auxiliary electrode protection plate in the cold cathode ionization vacuum gauge according to the first embodiment of the invention.

FIG. 6A is a plan diagram illustrating a discharge starting auxiliary electrode according to a second embodiment of the invention.

FIG. 6B is a side diagram illustrating the discharge starting auxiliary electrode according to the second embodiment of the invention.

FIG. 7A is plan diagram illustrating a discharge starting auxiliary electrode according to a third embodiment of the invention.

FIG. 7B is a side diagram illustrating the discharge starting auxiliary electrode according to the third embodiment of the invention.

FIG. 7C is a cross sectional diagram illustrating the discharge starting auxiliary electrode according to the third embodiment of the invention.

FIG. 8 is a traverse cross sectional diagram illustrating a cold cathode ionization vacuum gauge according to a fifth embodiment of the invention.

FIG. 9 is a cross sectional schematic diagram taken along the line a-b of FIG. 8.

FIG. 10 is an enlarged diagram of C portion of FIG. 8.

FIG. 11A is a side diagram illustrating a discharge starting auxiliary electrode according to a sixth embodiment of the invention.

FIG. 11B is a cross sectional diagram illustrating the discharge starting auxiliary electrode according to the sixth embodiment of the invention.

FIG. 11C is a front elevation diagram illustrating the discharge starting auxiliary electrode according to the sixth embodiment of the invention.

FIG. 12A is a side diagram illustrating a discharge starting auxiliary electrode according to a seventh embodiment of the invention.

FIG. 12B is a cross sectional diagram illustrating the discharge starting auxiliary electrode according to the seventh embodiment of the invention.

FIG. 12C is a front elevation diagram illustrating the discharge starting auxiliary electrode according to the seventh embodiment of the invention.

FIG. 13 is an enlarged diagram of the discharge starting auxiliary electrode of FIGS. 12A to 12C.

FIG. 14A is a side diagram of a discharge starting auxiliary electrode according to an eighth embodiment of the invention.

FIG. 14B is a cross sectional diagram of the discharge starting auxiliary electrode according to the eighth embodiment of the invention.

FIG. 14C is a front elevation diagram of the discharge starting auxiliary electrode according to the eighth embodiment of the invention.

FIG. 15A is a side diagram of a discharge starting auxiliary electrode according to a ninth embodiment of the invention.

FIG. 15B is a cross sectional diagram of the discharge starting auxiliary electrode according to the ninth embodiment of the invention.

FIG. 15C is a front elevation diagram of the discharge starting auxiliary electrode according to the ninth embodiment of the invention.

FIG. 16A is a diagram illustrating an embodiment using a discharge starting auxiliary electrode and an auxiliary electrode protection plate of a cold cathode ionization vacuum gauge according to the invention.

FIG. 16B is a diagram illustrating the embodiment using a discharge starting auxiliary electrode and an auxiliary electrode protection plate of a cold cathode ionization vacuum gauge according to the invention.

### DETAILED DESCRIPTION OF THE INVENTION

Embodiments for carrying out the present invention will be described referring to the drawings. Members, layouts and the like described hereinafter are embodied examples of the invention and are not limited. It is a matter of course to include various modifications without departing from the spirit of the invention.

### Embodiment 1

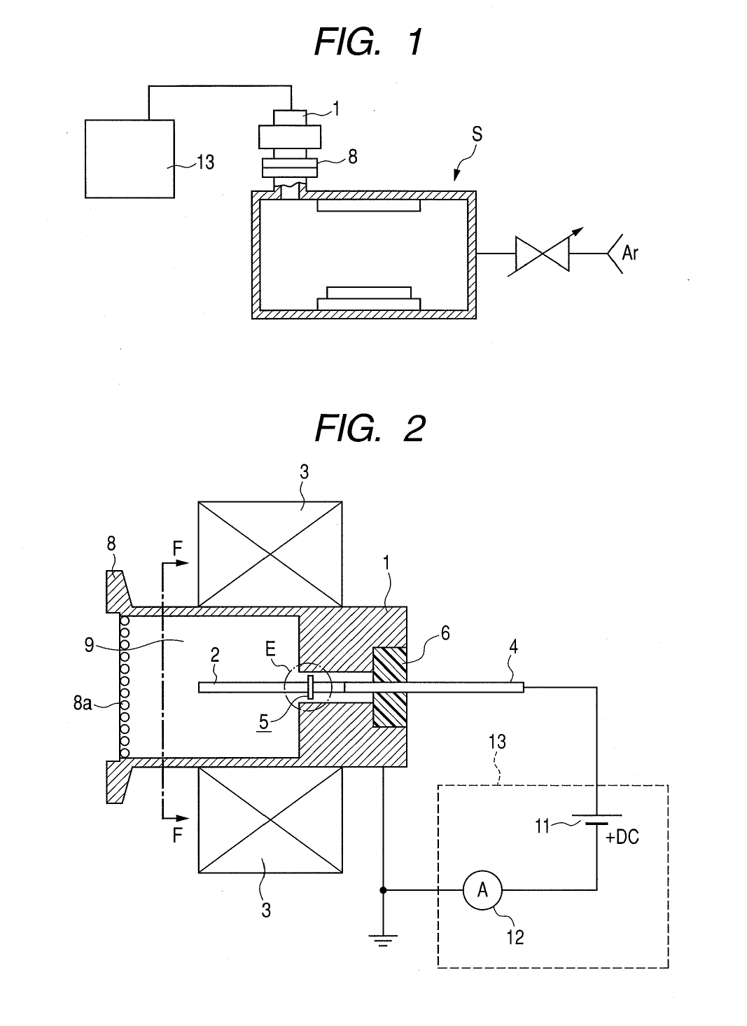

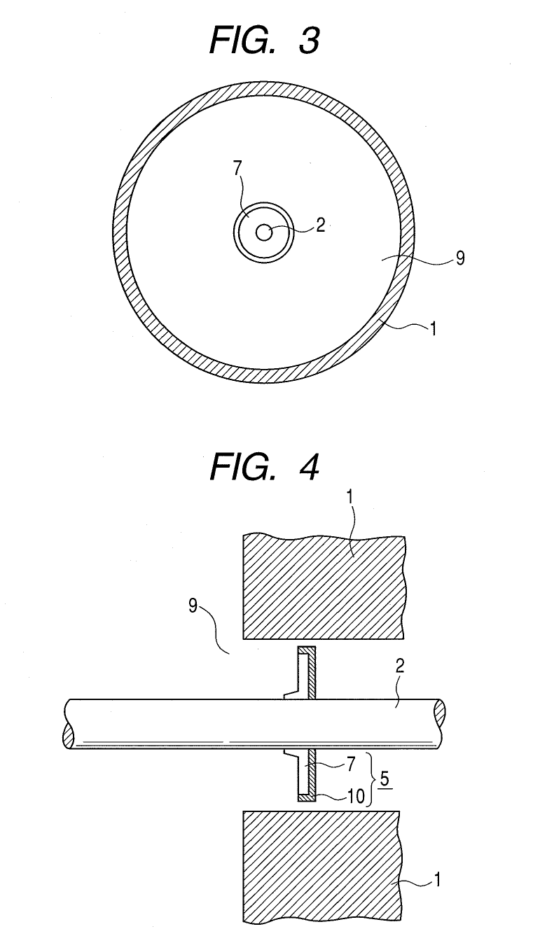

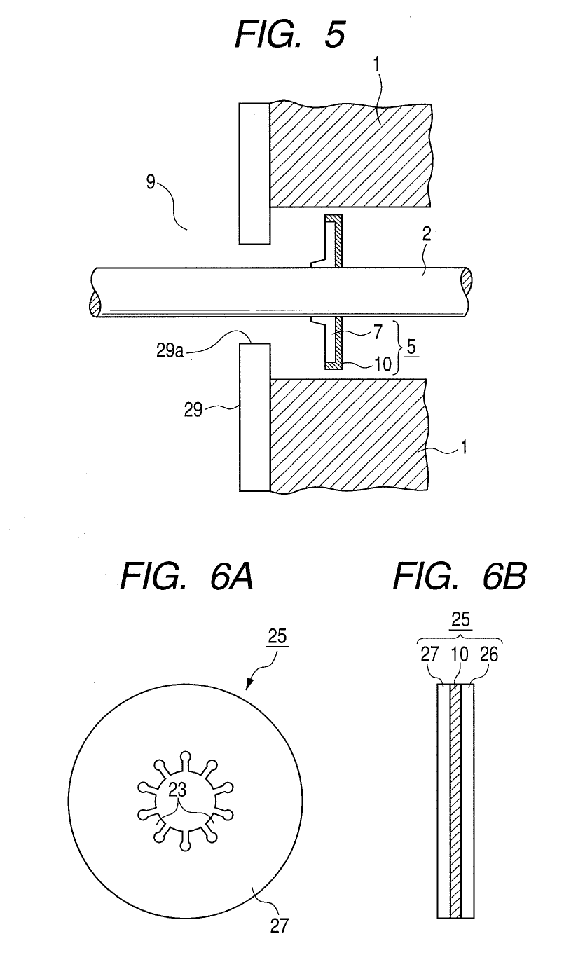

FIGS. 1 to 4 are drawings for illustrating a vacuum processing apparatus and a cold cathode ionization vacuum gauge mounted on this vacuum processing apparatus according to a first embodiment of the present invention. FIG. 1 is a cross sectional schematic diagram of a vacuum processing apparatus provided with the cold cathode ionization vacuum gauge according to the invention. FIG. 2 is a transverse cross sectional schematic diagram of the cold cathode ionization vacuum gauge according to the invention. FIG. 3 is a cross sectional schematic diagram taken along the line of F-F of FIG. 2. FIG. 4 is an enlarged diagram illustrating an enlarged E portion of FIG. 2. FIG. 5 is a diagram illustrating an application example of using an auxiliary electrode protection plate (cathode auxiliary electrode protection plate).

As illustrated in FIG. 1, a cold cathode ionization vacuum gauge is mounted on the wall surface (hatched portion) of a known vacuum container forming a vacuum processing apparatus S. The cold cathode ionization vacuum gauge is mounted in an airtight state in the opening of the wall surface of the vacuum container. Reference numeral 1 in the drawing indicates a measuring element container (cathode) forming a cold cathode ionization vacuum gauge, reference numeral 8 indicates a connection flange and reference numeral 13 indicates a gauge operating circuit.

Although, in the specification of this application, for instance, a sputtering system will be described as an example of a vacuum processing apparatus S, the present invention is not limited thereto. Additionally, for example, to a deposition system such as a PVD system or CVD system, an ashing apparatus or a dry-etching apparatus, the cold cathode ionization vacuum gauge according to the invention is preferably applicable.

FIG. 2 is a transverse cross sectional schematic diagram of the cold cathode ionization vacuum gauge according to this embodiment. In FIG. 2, like parts as in FIG. 1 refer to like reference numerals. The cold cathode ionization vacuum gauge is an inverted magnetron-type gauge, which has main components of a measuring element container 1 which is a cathode, a rod-like anode 2 and a magnet 3 acting as magnetic means for making a magnetic field that is disposed on the outer circumference of the measuring element container 1 which is a cathode.

The measuring element container 1 (cathode) is substantially a cylindrical or tubular metal member, and has a discharge space 9 on one side in its internal part. The measuring element container 1 is open at one end on the discharge space 9 side and sealed by an insulating member 6 at one end on the side opposite thereto. A connection flange 8 and a filter 8a are disposed at one end portion on the open discharge space 9 side. The filter 8a is made of e.g., stainless and the insulating member 6 contains an insulating stone such as are made of alumina ceramic. A current leading-in rod 4 goes through the insulating member 6 and is fixed to the insulating member 6 in an airtight state.

By the attachment of the connection flange 8 of the measuring element container 1 to the opening of the vacuum container, the space in the vacuum container and the discharge space 9 in the measuring element container 1 are brought into the state in which they can be in communication through the filter 8a. Thus, the pressure in the internal space of the vacuum container can be measured. The magnet 3 is formed and attached in ring shaped so as to surround the outer circumference of the measuring element container 1. The magnet 3 preferably includes a ferrite magnet and the like.

Anode 2 is a rod-like anode electrode, which is disposed in the discharge space 9 formed in an internal part of the measuring element container (cathode) 1 and is connected to the current leading-in rod 4 at one end side. The current leading-in rod 4 is connected to the vacuum gauge operating circuit 13 outside the measuring element container 1. The vacuum gauge operating circuit 13 contains a high-voltage power source 11 which applies voltage and a discharge current detection part 12 which measures the discharge current flowing through the gauge operating circuit 13. As described below, a discharge starting auxiliary electrode 5 (discharge starting auxiliary electrode plate 7) is mounted in a state electrically connected to the rod-like anode 2. The discharge starting auxiliary electrode is to be the electrode mounted on an anode or a cathode. The discharge starting auxiliary electrode is to include an electrode whose electric potential is the same as that of the electrode where the discharge starting auxiliary electrode is mounted, and the discharge starting auxiliary electrode functions to aid in the concentration of an electric field. In addition, the electrical connection includes the connection via a lead or the direct connection of a discharge starting auxiliary electrode to a cathode or an anode.

FIG. 3 is a schematic diagram illustrating the mounted state of the discharge starting auxiliary electrode 5 to the cold cathode ionization vacuum gauge, and a cross sectional schematic diagram taken along the line of F-F of FIG. 2. FIG. 4 illustrates an enlarged E portion of FIG. 2 for showing the relation between the discharge starting auxiliary electrode 5 and the wall surface of the measuring element container (cathode) 1. In FIGS. 3 and 4, like parts as are in FIG. 2 refer to like reference numerals.

The discharge starting auxiliary electrode 5 has a discharge starting auxiliary electrode plate 7. The discharge starting auxiliary electrode plate is substantially a ring-like member, and made of sheet metal of high corrosion resistance such as stainless steel of e.g., SUS 304, a nickel alloy or refractory materials. The discharge starting auxiliary electrode plate 7 is preferably not more than 100 micrometers in thickness and, in particular, desirably formed to be 1 micrometer to 10 micrometers. A thinner discharge starting auxiliary electrode plate has a greater effect for inducing the emission of electrons at low voltages.

Since the discharge starting auxiliary electrode plate 7 is mounted with anode 2 press-fitted in its opening at the central portion as illustrated in FIG. 4, the diameter of this opening is a little smaller than that of anode 2. Although the distance between the discharge starting auxiliary electrode plate 7 and the wall surface of the measuring element container (cathode) 1 is not particularly restricted, it is preferably not less than 0.2 mm. Furthermore, by using a fastening member as an alternative for being press-fitted, the discharge starting auxiliary electrode plate 7 may be fixed to anode 2.

On the insulating member 6 side (on the side opposite to the connection flange 8, which is the connection part with respect to a vacuum container) of the discharge starting auxiliary electrode plate 7, a carbon nanotube layer 10 is formed. Due to the fact that the carbon nanotube layer 10 is formed on the opposite side of the discharge space 9 side (on the insulating member 6 side), the damage to the carbon nanotube layer 10 resulted from the impact from charged particles entering from the vacuum container side or the adhesion of sputtered film can be prevented or reduced. The carbon nanotube layer 10 is formed so that a carbon nanotube layer also resides at the periphery of the discharge starting auxiliary electrode plate 7 that is in the position opposite to the measuring element container (cathode) 1. Owing to this structure, the discharge starting auxiliary electrode plate 7 can block particles from entering from the connection flange 8 side, thus preventing or reducing the adhesion of particles to carbon nanotube layer 10.

A carbon nanotube is comprised of a single layer or multiple layers of 6-membered ring networks made from carbons coupled coaxially and tubular shaped. A carbon nanotube, in general, includes a tubular shape having nanometer order diameter, pointed end and large aspect ratio, exhibits high conductivity, and is likely to trigger an electron tunneling effect. In the present invention, a carbon nanotube layer is used as a minute protrusion electrode to create a concentrated electric field. As a result of the concentrated electric field on the carbon nanotube tip portion, triggering discharge can quickly occur, which demonstrates an advantage of the invention.

In addition, as illustrated in FIG. 5, an auxiliary electrode protection plate 29 (cathode auxiliary electrode protection plate 29) having an inside diameter smaller than the diameter of the discharge starting auxiliary electrode 5 is attached to the bottom of the measuring element container 1 in the discharge space 9. Therefore, the damage to carbon nanotube layer 10 resulting from the collision or adhesion of particles flying from the vacuum container side is effectively prevented or reduced. The auxiliary electrode protection plate 29 is a plate-like member of substantially disk or rectangular shape, and has a circular opening 29a formed at the central portion. The auxiliary electrode protection plate 29 is disposed so that anode 2 is inserted in the central portion of opening 29a. The inside diameter of opening 29a that is formed in the auxiliary electrode protection plate 29 is smaller than the diameter of the discharge starting auxiliary electrode 5. Therefore, charged particles and the like having entered from the vacuum container side first collide against the auxiliary electrode protection plate 29, and thus the direct collision thereof with the carbon nanotube layer 10 can be reduced.

An auxiliary electrode protection plate 30 (anode auxiliary electrode protection plate 30) to be used in a tenth embodiment (refer to FIGS. 16A and 16B) as described below may be applied to the cold cathode ionization vacuum gauge according to this embodiment. In this case, the auxiliary electrode protection plate 30 whose diameter is larger than that of the discharge starting auxiliary electrode 5 is mounted on anode 2 on the side closer to the vacuum container than the discharge starting auxiliary electrode 5. Therefore, charged particles having entered from the vacuum container side first collide against the auxiliary electrode protection plate 30. Thus, the direct collision thereof with the carbon nanotube layer 10 can be reduced.

The discharge starting auxiliary electrode plate 7 may be a conductive material. Furthermore, the discharge starting auxiliary electrode plate 7 may be a insulator or semiconductor member as long as it can support a carbon nanotube and have such a construction that the carbon nanotube is in contact with the electrode on which the discharge auxiliary electrode plate is mounted. In this case, the same advantage as in the case of using discharge starting auxiliary electrode plate 7 made of a conductive material can be obtained. For example, in the case of using an insulator or a semiconductor instead of discharge starting auxiliary electrode plate 7, it is preferable that processing in which the carbon nanotube is oriented in a predetermined direction with respect to the insulator or semiconductor is made, and the carbon nanotube layer is oriented in the above-mentioned predetermined direction on the insulator or semiconductor. In addition, the carbon nanotube layer having been formed on the insulator or the semiconductor may be electrically connected to at least one of anode 2 and the measuring element container 1 which is a cathode.

In this embodiment, a member on which the carbon nanotube layer 10 is formed such as discharge starting auxiliary electrode plate 7 does not need to be conductive, and may be any support member that can support the carbon nanotube layer 10.

In this embodiment, basically, anode 2 and the measuring element container 1 which is a cathode do not need to be brought close to each other or a high voltage does not need to be applied to anode 2. Essentially, the local concentration of an electric field is made to occur in the discharge space 9 to be formed by the anode 2 and the measuring element container 1. Therefore, the discharge can be started in a short time. Furthermore, the discharge starting auxiliary electrode 5 is provided for the electric field concentration. In order to further enhance the electric field concentration effects even more using the discharge starting auxiliary electrode 5, the discharge starting auxiliary electrode 5 includes the carbon nanotube layer 10. The carbon nanotube layer 10 is electrically connected to anode 2 (or the measuring element container 1 which is a cathode as described below and both anode 2 and the measuring element container 1).

In the first embodiment of the present invention, a discharge starting auxiliary electrode has a carbon nanotube layer, so that the discharge starting auxiliary electrode which creates the electric field concentration even under normal circumstances includes the assembly of protrusion electrodes of nano order, which can effectively generate the concentrated electric field. Accordingly, even if the distance between an anode and a cathode is not made shorter or the application voltage between the electrodes is not made higher, the discharge can be triggered in a short time.

As described above, the first embodiment according to the invention is basically characterized in that a discharge starting auxiliary electrode has a carbon nanotube layer. The discharge starting auxiliary electrode 5 does not necessarily have the discharge starting auxiliary electrode plate 7. This reason, as described above, is that the carbon nanotube layer 10 included in the discharge starting auxiliary electrode 5 can further enhance electric field concentration effects. Therefore, even if no member having the function of supporting the carbon nanotube layer 10 such as the discharge starting auxiliary electrode plate 7 is used, for instance, the carbon nanotube layer 10 can theoretically be constructed so as to be oriented in a predetermined direction. Thus, it is preferable to form the discharge starting auxiliary electrode 5 only with a carbon nanotube layer so as not to have the member supporting the carbon nanotube layer 10 (for example, the discharge starting auxiliary electrode plate 7).

### Embodiment 2

A second embodiment according to the present invention will be described. In this embodiment, the construction of a discharge starting auxiliary electrode differs from that of FIGS. 3 and 4. The construction of a cold cathode ionization vacuum gauge or a vacuum processing apparatus other than the above-mentioned construction are the same as are FIGS. 1 and 2. FIG. 6A is a plan diagram illustrating a discharge starting auxiliary electrode 25 according to this embodiment. FIG. 6B is a side diagram thereof.

As illustrated in FIG. 6A, a discharge starting auxiliary electrode plate 27 that forms the discharge starting auxiliary electrode 25 has an opening formed for allowing the rod-like anode 2 to be inserted at the central portion. The elastic support claws 23 for mounting the discharge starting auxiliary electrode plate 27 on anode 2 are provided radially around the inner circumference of this opening. Due to the support claws 23, the insertion pressures on the occasion when mounting the discharge starting auxiliary electrode plate 27 on anode 2 can be made uniform and easily be assembled. The precision of the mounting position of the discharge starting auxiliary electrode plate 27 can be improved.

As illustrated in FIG. 6B, the discharge starting auxiliary electrode 25, with a coating protection disk 26 acting as a protective member bonded so as to cover a coating layer of carbon nanotube (carbon nanotube layer 10), is integrally constructed. The coating protection disk 26 is to protect the surface of the carbon nanotube layer 10 and further to suppress the excess emission of electric field electrons, thus obtaining the stable self-sustaining discharge current.

In addition, the coating protection disk 26 acts to prevent or reduce the occurrence of damage to the coating layer of carbon nanotube during the attachment or detachment of the discharge starting auxiliary electrode 25. Thus, it is easy to handle the discharge starting auxiliary electrode 25 during assembly or repair. The coating protection disk 26 may be made of the same material as that of the discharge starting auxiliary electrode plate 27. The thickness of the coating protection disk 26 is preferably equal to or less than that of the discharge starting auxiliary electrode plate 27.

### Embodiment 3

A third embodiment according to the present invention will be described. In this embodiment, likewise the construction of a discharge starting auxiliary electrode differs from that of FIGS. 3 and 4. The constructions of a cold cathode ionization vacuum gauge or a vacuum processing apparatus other than the above-mentioned construction are the same as those of FIGS. 1 and 2.

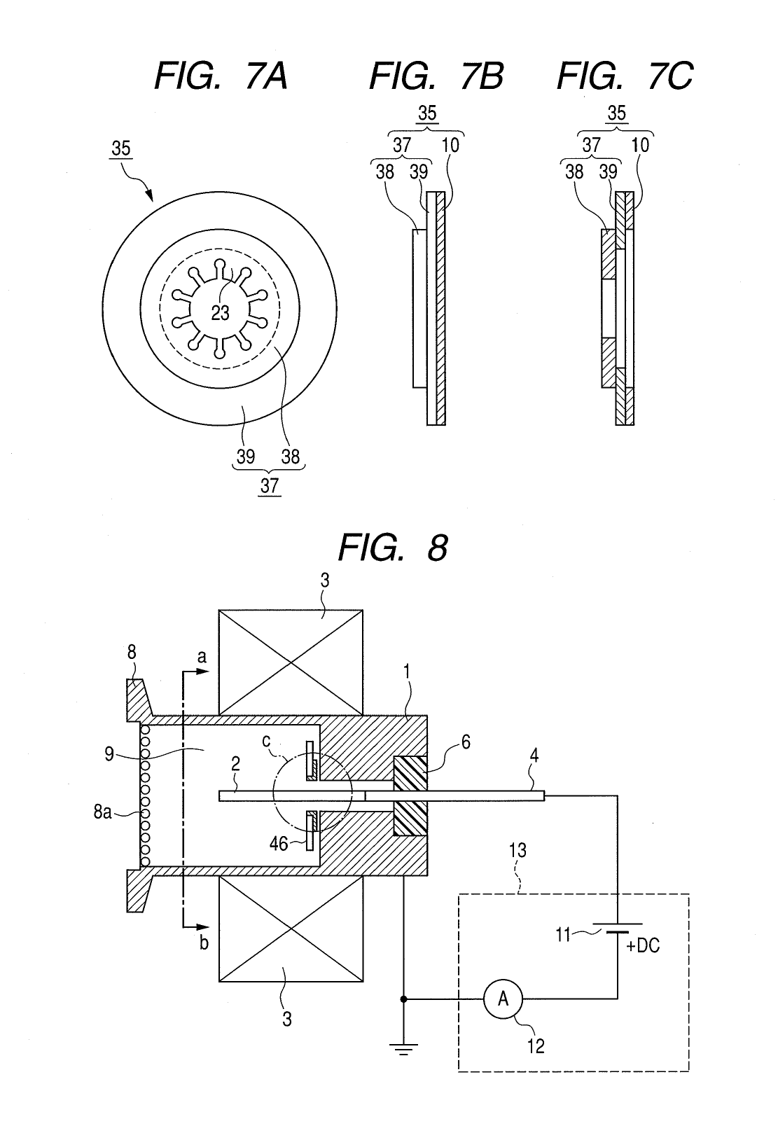

FIG. 7A is a plan diagram illustrating a discharge starting auxiliary electrode 35 according to this embodiment. FIG. 7B is a side diagram thereof. FIG. 7C is a cross sectional diagram thereof. The discharge starting auxiliary electrode 35 according to this embodiment is provided with a discharge starting auxiliary electrode plate 37 having two members, that is, an inner electrode member 38 and an outer electrode member 39 which is fixed to the outer circumferential side of the inner electrode member 38.

The discharge starting auxiliary electrode plate 37 has the structure that an electrode plate (outer electrode member 39) functioning as the discharge starting auxiliary electrode plates 7 and 27 described in the above-mentioned embodiments is fixed to the outer circumferential side of the portion (inner electrode member 38) to be mounted on the anode 2. Owing to such a dual structure, the discharge starting auxiliary electrode plate (outer electrode member 39) with a thickness of about 0.2 micrometers to 5 micrometers can be easily mounted on anode 2. The outer electrode member 39 has the carbon nanotube layer 10 formed as illustrated in FIG. 6B.

The inner electrode member 38 is a ring-like member having an opening for allowing anode 2 to be inserted and mounted at the central portion as illustrated in FIG. 7C. The outer electrode member 39 is a ring-like member having a diameter larger than that of the inner electrode member 38. In this embodiment, although as illustrated in FIG. 7A, the inner electrode member 38 has the elastic support claws 23 which is formed as shown in the discharge starting auxiliary electrode plate 27 illustrated in FIG. 6A. It may be so constructed that anode 2 is press-fitted in the opening without forming the support claws 23.

The outer electrode member 39 is attached by e.g., spot welding on the insulating member 6 side of the inner electrode member 38. The carbon nanotube layer 10 is formed on the insulating member 6 side of the outer electrode member 39.

Since the outer electrode member 39 is thin, the electric field concentration is thought to occur to some extent at the outer circumferential edge portion even in the state in which no carbon nanotube layer 10 is formed. Furthermore, by forming the outer electrode member 39 thinner or forming it with protrusions at the outer circumferential edge portion, intensified electric field concentration effects can be expected.

### Embodiment 4

The manufacturing method of a discharge starting auxiliary electrode according to the present invention will be described. First, the discharge starting auxiliary electrode plate 7, 27, 37 (outer electrode member 39) is formed in a predetermined shape from a thin plate having a predetermined thickness by e.g., photo-etching, pressing or laser processing. The carbon nanotube layer 10 is formed by spraying a solvent of dispersed carbon nanotube on one surface of the discharge starting auxiliary electrode plate 7, 27, 37 and drying it. The coating protection disk 26 which is a protective member illustrated in FIG. 6B is fixed by e.g., spot welding to the surface on which the carbon nanotube layer 10 of the discharge starting auxiliary electrode plate 27 is formed.

The coating protection disk 26 of FIG. 6B may be applied to a discharge starting auxiliary electrode of other embodiments such as in FIG. 7A. In this case, likewise, the coating protection disk 26 which is a protective member may be fixed by e.g., spot welding to the surface on which the carbon nanotube layer 10 of the discharge starting auxiliary electrode plate is formed.

In addition to the above-mentioned method (spraying), the carbon nanotube layer 10 can be formed by dipping the discharge starting auxiliary electrode plate 7, 27, 37 in the solvent in which carbon nanotubes are dispersed or by utilizing a metal such as nickel plating process. In the case of utilizing plating process, by conducting plating processing in an electrolytic bath in which carbon nanotubes are dispersed, a plated layer (carbon nanotube layer 10) in which the carbon nanotubes are dispersed can be obtained.

The mounting method of the discharge starting auxiliary electrode 5, 25, 35 (discharge starting auxiliary electrode plate 7, 27, 37) on anode 2 in the measuring element container 1 will be described. An example of mounting the discharge starting auxiliary electrode 5 on anode 2 will be described. The case of other discharge starting auxiliary electrodes is the same. On the occasion of mounting the discharge starting auxiliary electrode 5 on anode 2 in the measuring element container 1, the discharge starting auxiliary electrode 5 is inserted from the opening of the measuring element container 1 in the state in which filter 8a has been removed, and mounted so that anode 2 is inserted in the opening at the central portion of the discharge starting auxiliary electrode 5. Whereby, as illustrated in FIGS. 2 and 4, the discharge starting auxiliary electrode 5 is fixed to anode 2.

The discharge starting auxiliary electrode 5 is inserted such that the carbon nanotube layer 10 resides on the insulating member 6 side. This reason is to protect the carbon nanotube layer 10 from the impact of charged particles or the adhesion of a sputtered film from the opening side of the measuring element container. The discharge starting auxiliary electrode 5 is inserted to the position in the vicinity of the bottom of the discharge space 9 as illustrated in FIG. 2. Filter 8a is finally mounted.

The mounting method in the case in which the support claws 23 are formed on the inner circumferential side as is the discharge starting auxiliary electrode 25 is the same. In this case, the discharge starting auxiliary electrode 25 is inserted in the state in which the support claws 23 are bent toward the opening side of the measuring element container 1. Since the bent support claws 23 biases anode 2 inward at all times by the same action as a leaf spring, the discharge starting auxiliary electrode 25 can be firmly fixed with respect to anode 2.

When taking out the discharge starting auxiliary electrode mounted on anode 2, the discharge starting auxiliary electrode is dismounted from anode 2 using common tools such as pliers or tweezers. In the case of the discharge starting auxiliary electrode 27 having the support claws 23, the support claws 23 are raised up inwards using common tools such as pliers or tweezers to dismount it from anode 2.

As illustrated in FIG. 2, the discharge starting auxiliary electrode 5 is supported in a position between the bottom of the discharge space 9 that is formed in an internal part of the measuring element container 1 and the insulating member 6. The mounting position of the discharge starting auxiliary electrode 5 may be in the discharge space 9 as well as in a range of the presence of the anode 2. The discharge starting auxiliary electrode 25 or 35 may be positioned as is mentioned above.

According to the cold cathode ionization vacuum gauge of the present invention, due to the fact that a discharge starting auxiliary electrode coated with the carbon nanotube layer 10 is mounted on anode 2, the discharge can be triggered in a short time without complicating an apparatus. In addition, since a discharge starting auxiliary electrode is mounted in a replaceable manner onto a cold cathode ionization vacuum gauge, even if the discharge is unlikely to be triggered owing to the deterioration of the discharge starting auxiliary electrode, the state in which the discharge is unlikely to be triggered can be corrected by replacement with a new discharge starting auxiliary electrode.

### Embodiment 5

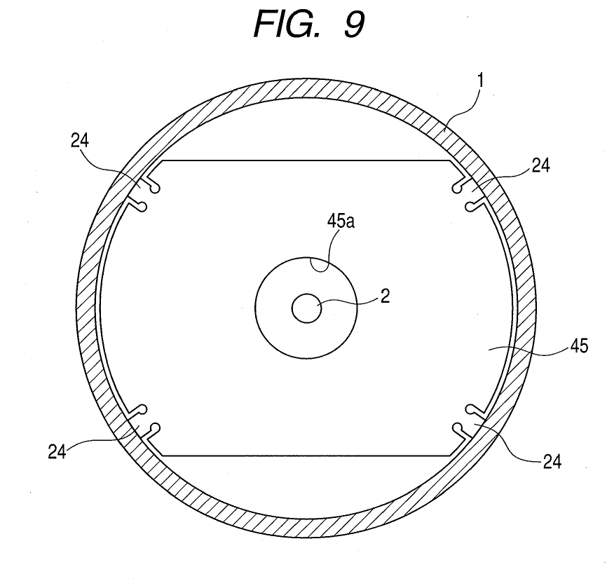

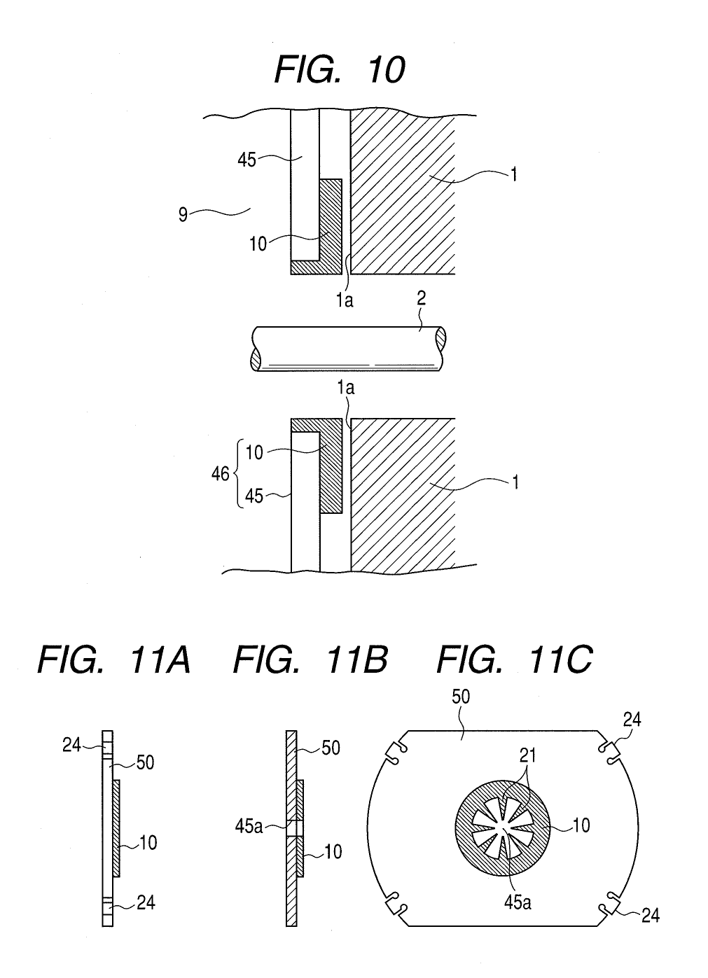

FIGS. 8 to 10 are diagrams illustrating a cold cathode ionization vacuum gauge mounted on a vacuum processing apparatus according to a fifth embodiment of the present invention. FIG. 8 is a traverse cross sectional schematic diagram of the cold cathode ionization vacuum gauge according to the invention. FIG. 9 is a cross sectional schematic diagram taken along the line of a-b of FIG. 8. FIG. 10 is an enlarged diagram illustrating an enlarged C portion of FIG. 8.

FIG. 8 is a traverse cross sectional schematic diagram of the cold cathode ionization vacuum gauge according to this embodiment. The fifth to tenth embodiments including this embodiment differ from the above-described first to fourth embodiments in the point that a discharge starting auxiliary electrode is mounted on the measuring element container 1 which is a cathode. Construction of the cold cathode ionization vacuum gauge or the vacuum processing apparatus other than the above-mentioned construction are the same as those of the first to fourth embodiments. In FIG. 8, like parts as in FIG. 2 refer to like reference numerals.

A discharge starting auxiliary electrode 46 in this embodiment has a discharge starting auxiliary electrode plate 45 which is substantially a rectangular plate-like member including an opening 45a at the central portion. The discharge starting auxiliary electrode plate 45 may be made of a sheet metal of high corrosion resistance such as stainless steel of e.g., SUS 304, a nickel alloy or refractory materials. The discharge starting auxiliary electrode plate 45 is preferably not more than 100 micrometers in thickness and, in particular, the thickness around the opening 45a is desirably formed to be 5 micrometers to 10 micrometers. A thinner discharge starting auxiliary electrode plate performs greater in inducing the emission of electrons at low voltages.

On the outer circumferential side of the discharge starting auxiliary electrode plate 45, a support claws 24 that are formed so as to have elasticity for mounting on the measuring element container (cathode) 1 are provided. The support claws 24 are deformed elastically, and formed so as to protrude a little from the periphery of the discharge starting auxiliary electrode plate 45. The support claws 24 contact with the inner wall of the measuring element container (cathode) 1, thereby holding the discharge starting auxiliary electrode plate 45 and providing the same electric potential as that of the cathode to the discharge starting auxiliary electrode plate 45.

The discharge starting auxiliary electrode plate 45 is mounted in the state in which the support claws 24 that are provided at the periphery contacts with the inside of the measuring element container (cathode) 1. The elastic support claws 24 bias the internal surface of the measuring element container (cathode) 1 outward. Thereby, the discharge starting auxiliary electrode plate 45 is held in the measuring element container (cathode) 1. The distance between the discharge starting auxiliary electrode plate 45 and anode 2 is not particularly limited, but preferably not less than 0.2 mm.

On the insulating member 6 side of the discharge starting auxiliary electrode plate 45, as illustrated in FIG. 10, the carbon nanotube layer 10 is formed. By the formation of the carbon nanotube layer 10 on the insulating member 6 side, the damage to the carbon nanotube layer 10 resulting from the impact of charged particles entering from a vacuum container side or the adhesion of sputtered film can be prevented or reduced.

The carbon nanotube layer 10 is formed by sticking carbon nanotube in a ring shape having a width of about 5 mm from the inside edge of the opening 45a of the discharge starting auxiliary electrode plate 45. That is, the carbon nanotube layer 10 resides in a position opposite to anode 2.

A carbon nanotube is a substance of a single layer or multiple layers of 6-membered ring networks to be made from carbons in coaxially tubular shape. A carbon nanotube, in general, has the tubular shape of diameter of nanometer order, pointed end the large aspect ratio, exhibits high conductivity, and is likely to trigger an electron tunneling effect. In the present invention, a carbon nanotube layer is used as a minute protrusion electrode to create a concentrated electric field. As a result of the concentrated electric field on the carbon nanotube tip, an excellent advantage of the invention is demonstrated in that the discharge can be triggered in a short time.

The manufacturing method of the discharge starting auxiliary electrode plate 45 according to the present invention will be described. First, the discharge starting auxiliary electrode plate 45 is formed in a predetermined shape from a thin plate by using, e.g., photo-etching, pressing or laser processing. The carbon nanotube layer 10 is formed by spraying a solvent of dispersed carbon nanotube on the surface on one side of the discharge starting auxiliary electrode plate 45 and drying it.

The carbon nanotube layer 10, in addition to the above-mentioned method (spraying), can also be formed by dipping the discharge starting auxiliary electrode plate 45 in a solvent in which carbon nanotubes are dispersed or by utilizing a metal such as nickel plating process. In the case of utilizing plating process, by conducting plating processing in an electrolytic bath in which carbon nanotubes are dispersed, a plated layer in which carbon nanotubes are dispersed can be obtained.

The mounting method of the discharge starting auxiliary electrode plate 45 on the measuring element container (cathode) 1 will be described. The discharge starting auxiliary electrode plate 45 is mounted from the opening side (the connection flange 8 side) of the measuring element container (cathode) 1 in the state in which filter 8a is removed. The discharge starting auxiliary electrode plate 45 is inserted to the position in the vicinity of the bottom of the discharge space 9 as illustrated in FIG. 8 in the state of allowing anode 2 to be inserted in the opening 45a thereof. Filter 8a is finally mounted.

On this occasion, the discharge starting auxiliary electrode plate 45, as illustrated in FIG. 10, is preferably disposed so that the carbon nanotube layer 10 is a little apart from or contacts with a stepped part 1a on the insulating member 6 side of the measuring element container (cathode) 1. The stepped part 1a is a wall surface of the measuring element container 1 on the insulating member side. This reason is to protect the carbon nanotube layer 10 from the impact of charged particles or the adhesion of sputtered film.

In the case of mounting the discharge starting auxiliary electrode plate 45 on the measuring element container (cathode) 1, it is mounted in the state in which the support claws 24 are bent toward the opening side of the measuring element container (cathode) 1. The bent support claws 24 continuously bias outward the inner wall of the measuring element container (cathode) 1 performing the same action as a leaf spring. Therefore, the discharge starting auxiliary electrode plate 45 is able to be securely held in a predetermined position in the measuring element container (cathode) 1.

When dismounting the discharge starting auxiliary electrode plate 45 that is mounted on the measuring element container (cathode) 1, common tools such as pliers or tweezers can be used. On this occasion, the support claws 24 are raised up to the inside using tools and then the discharge starting auxiliary electrode plate 45 is dismounted. The discharge starting auxiliary electrode plate 45 is disposed in the position a little apart from or contacts the stepped part 1a of the measuring element container (cathode) 1. The mounting position of the discharge starting auxiliary electrode plate 45 has only to be in the range of the presence of anode 2.

The advantage in the case of using the discharge starting auxiliary electrode plate 45 according to the present invention will be described. The discharge starting auxiliary electrode plate 45 coated with a carbon nanotube is mounted on the measuring element container (cathode) 1. Therefore, electrons are released owing to the electric field emission from a part of the carbon nanotube layer 10 which is opposite to anode 2 on the occasion of the application of high voltage to anode 2. This event, since the tip of the carbon nanotube that resides around the opening 45a of the discharge starting auxiliary electrode plate 45 is under the conditions in which the electric field concentration is more likely to occur than in any place in the measuring element container (cathode) 1, is caused by the reduction in the threshold value of the emission of electric field electrons

By using the discharge starting auxiliary electrode plate 45 coated with carbon nanotube, the same effect as in the case of decreasing the distance between anode 2 and the measuring element container (cathode) 1 and in the case of increasing the voltage to be applied to anode 2 can be obtained. Accordingly, since the electric field emission or the secondary electron emission takes place at the time of application of high voltage to anode 2, electrons acting as the trigger for starting discharge can be efficiently provided. As a result, the time period from the application of high voltage from the high voltage power source 11 to the start of self-sustaining discharge between the measuring element container (cathode) 1 and anode 2 can be shortened.

According to the cold cathode ionization vacuum gauge of this embodiment, due to the fact that the discharge starting auxiliary electrode plate 45 coated with the carbon nanotube layer 10 is mounted on the measuring element container (cathode) 1 side, the discharge can be triggered in a shorter time. Since the discharge starting auxiliary electrode plate 45 is mounted in a replaceable manner on the cold cathode ionization vacuum gauge, even if the discharge is unlikely to be triggered owing to the deterioration of the discharge starting auxiliary electrode plate 45, the state in which the discharge is unlikely to be triggered can be corrected by replacement with a new discharge starting auxiliary electrode plate 45.

### Embodiment 6

FIG. 11A is a side diagram illustrating a discharge starting auxiliary electrode according to a sixth embodiment of the present invention. FIG. 11B is a cross sectional diagram thereof. FIG. 11C is a front elevation diagram thereof. Also in embodiments hereinafter, the same advantages as in the fifth embodiment can be obtained. Each of the discharge starting auxiliary electrodes 50, 55, 60 and 65 can be manufactured and handled in the same way as that of the fifth embodiment.

All the discharge starting auxiliary electrodes 50, 55, 60 and 65 described in the following embodiments can be mounted detachably in an internal element of the measuring element container (cathode) 1 as illustrated in FIG. 8. In FIGS. 11A to 11C, the same members, layouts and the like as in FIGS. 8 to 10 refer to like reference numerals, and detailed descriptions thereof will be omitted. The discharge starting auxiliary electrode 50 according to this embodiment has an acute-angled protrusion 21 pointed to anode 2 side formed on the inside of the opening 45a of the above-described discharge starting auxiliary electrode plate 45.

By coating the surface of the acute-angled protrusion 21 with carbon nanotube, owing to the combined effects of the emission effect of electric field electrons due to the carbon nanotube and the acute-angled protrusion shape, the time period from the application of a high voltage to the start of self-sustaining discharge can be shortened further. Reference numeral 24 indicates an elastic support claw.

### Embodiment 7

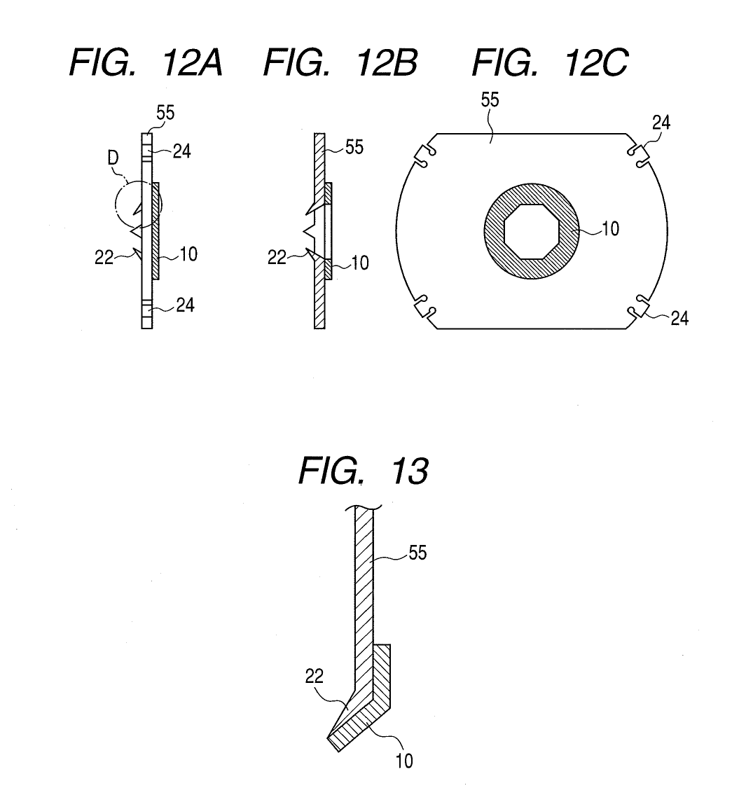

FIG. 12A is a side diagram illustrating a discharge starting auxiliary electrode according to a seventh embodiment of the present invention. FIG. 12B is a cross sectional diagram thereof. FIG. 12C is a front elevation diagram thereof. In FIGS. 12A to 12C, like parts as in FIGS. 11A to 11C refer to like reference numerals. A discharge starting auxiliary electrode 55 according to this embodiment is an electrode in which acute-angled protrusion 21 of the discharge starting auxiliary electrode 50 illustrated in FIG. 11A is bent. FIG. 13 illustrates an enlarged diagram in the vicinity of the D portion of the discharge starting auxiliary electrode as illustrated in FIG. 12A.

In the discharge starting auxiliary electrode 55, the acute-angled protrusion 22 is bent at an angle of about 45 degrees with respect to the discharge starting auxiliary electrode 55 as illustrated in FIG. 13. Since the tip of the acute-angled protrusion 22 is pointed to the center of the rod-like anode 2 at an arbitrary angle within 90 degrees, the discharge from the tip can be triggered. On this occasion, the carbon nanotube layer 10 is formed on the surface of the acute-angled protrusion 22 opposite to anode 2 so that a part of the carbon nanotube is positioned in opposition to anode 2.

Inasmuch as the acute-angled protrusion 22 is bent in the axial direction of anode 2 as illustrated in FIG. 13, electrons having been emitted from the tip of the acute-angled protrusion 22 are likely to be involved in the lines of magnetic force parallel to the axial direction of anode 2. Thus, the flying distance of electrons is thought to be relatively extended. Therefore, electrons acting as a discharge starting trigger can be efficiently provided. Reference numeral 24 indicates a support claw.

### Embodiment 8

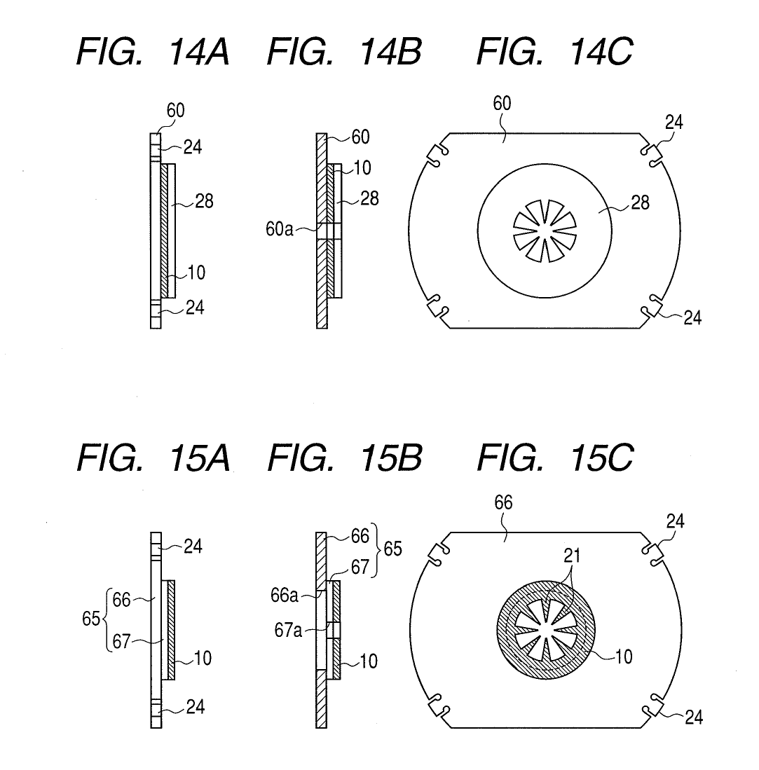

FIG. 14A is a side diagram illustrating a discharge starting auxiliary electrode according to an eighth embodiment of the present invention. FIG. 14B is a cross sectional diagram thereof. FIG. 14C is a front elevation diagram thereof. In FIGS. 14A to 14C, like parts as in FIGS. 11A to 11C refer to like reference numerals. In a discharge starting auxiliary electrode 60 according to this embodiment, a coating protection plate 28 acting as a protective member to protect the carbon nanotube layer 10 is attached to the discharge starting auxiliary electrode 50 of FIG. 11A to be in an integral structure.

The coating protection disk 28 is fixed by e.g., spot welding to the surface on which the carbon nanotube layer 10 is formed at the discharge starting auxiliary electrode 60. It becomes unnecessary to pay attention to the protection of the carbon nanotube layer 10 on the occasion of attachment or detachment of the discharge starting auxiliary electrode 60, thus making for easy handling. By attaching the coating protection disk 28 which acts as a protective member to the above-described discharge starting auxiliary electrode plate 45, 55, the same advantage can be obtained. In addition, a protective member may be attached to a discharge starting auxiliary electrode 65 as described below.

### Embodiment 9

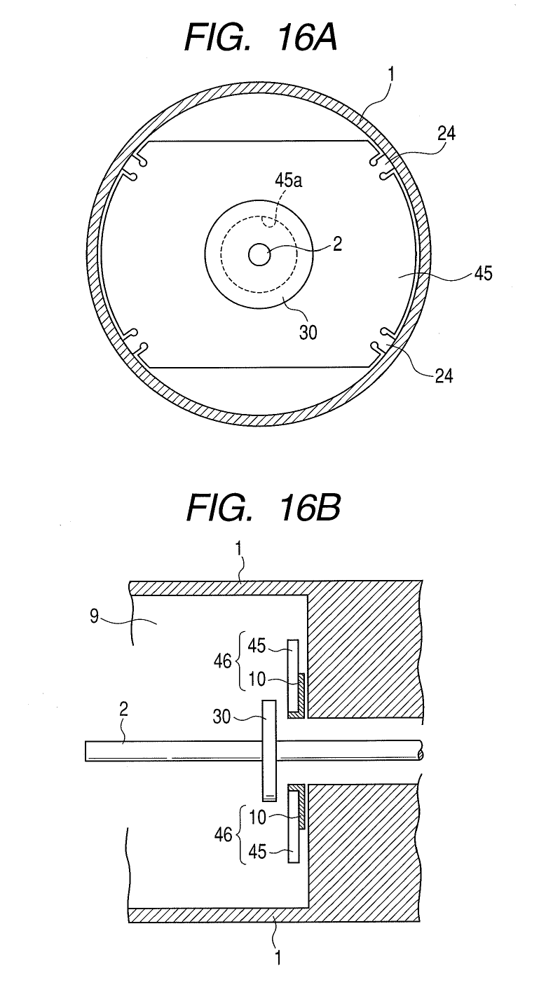

FIG. 15A is a side diagram illustrating a discharge starting auxiliary electrode according to a ninth embodiment of the present invention. FIG. 15B is a cross sectional diagram thereof. FIG. 15C is a front elevation diagram thereof. In FIGS. 15A to 15C, like parts as are in FIGS. 12A to 12C and FIGS. 14A to 14C refer to like reference numerals. In a discharge starting auxiliary electrode 65 according to this embodiment, an inner electrode member 67 is attached around an opening 66a of an outer electrode member 66. That is, the inner electrode member 67 is attached so as to cover the inside edge of the opening 66a of the outer electrode member 66 to be mounted on the measuring element container (cathode) 1.

An opening 67a of the central portion of the inner electrode member 67 is an opening for allowing anode 2 to be inserted. The outer electrode member 66 is fixed to the outer circumferential side of the inner electrode member 67. A support claw 24 are formed at the periphery of the outer electrode member 66 for detachably mounting on the inside of the measuring element container (cathode) 1 as illustrated in FIG. 15C.

The inner electrode member 67 has the same functions as the above-described discharge starting auxiliary electrode plates 45 and 50, and is made of a member of still smaller plate thickness. Owing to such a dual structure, the thickness of the edge portion (inside edge portion in the opening 67a) of the discharge starting auxiliary electrode 65 from which electrons are emitted can be constructed to be extremely small, for example, about 0.2 micrometers to 5 micrometers.

The inner electrode member 67 is a ring-like member having the opening 67a whose diameter is larger than that of anode 2. The outer electrode member 66 is a ring-like member having the opening 66a whose diameter is larger than that of the opening 67a of the inner electrode member 67. In this embodiment, as described above, the same support claws 24 are formed at the peripheral side of the outer electrode member 66 as the discharge starting auxiliary electrode plate 45 as illustrated in FIG. 9. In addition, the inner electrode member 67 is attached by e.g., spot welding on the insulating member 6 side of the outer electrode member 66, and the carbon nanotube layer 10 is formed on the insulating member 6 side of the inner electrode member 67.

Since the inner electrode member 67 is extremely thin, even in the state in which no carbon nanotube layer 10 is formed, the concentrated electric field will occur to some extent at the outer circumferential edge portion. By the formation of an inner electrode member 67 of even smaller thickness, further-concentrated electric field effects can be expected. As a matter of course, it is preferable that the coating protection disk 28 which acts as a protective member is attached to the discharge starting auxiliary electrode 65 or that an acute-angled protrusion 21 is formed at the opening 67a of the inner electrode member 67.

### Embodiment 10

FIGS. 16A and 16B are diagrams illustrating an embodiment using an auxiliary electrode protection plate in addition to a discharge starting auxiliary electrode in a cold cathode ionization vacuum gauge according to the present invention. FIG. 16B is a diagram illustrating the state in which a discharge starting auxiliary electrode plate 45 and an auxiliary electrode protection plate 30 are mounted on the measuring element container (cathode) 1 of the cold cathode ionization vacuum gauge illustrated in FIG. 8. FIG. 16A is a cross sectional schematic diagram taken along the line of a-b of FIG. 8 on this occasion. FIG. 16B illustrates an enlarged C portion of FIG. 8.

In this embodiment, as is illustrated in FIG. 16B, the auxiliary electrode protection plate 30 (anode auxiliary electrode protection plate 30) is mounted onto anode 2, and the discharge starting auxiliary electrode 46 is mounted as in FIG. 8 on the measuring element container (cathode) 1 side. The auxiliary electrode protection plate 30 has a diameter larger than that of the opening 45a of the discharge starting auxiliary electrode plate 45, and mounted on the side closer to the vacuum container than the discharge starting auxiliary electrode plate 45. Therefore, charged particles having entered from the vacuum container side first collide with the auxiliary electrode protection plate 30, and thus would not directly collide with the carbon nanotube layer 10.

Consequently, the damage to the carbon nanotube layer 10 resulting from the impact or the adhesion of sputtered film can be more effectively prevented or reduced. The same advantages can be obtained by using the auxiliary electrode protection plate 30 with respect to the cold cathode ionization vacuum gauge in which the discharge starting auxiliary electrodes 50, 55, 60 and 65 are provided. Although in FIG. 16B, the rod-like anode 2, the auxiliary electrode protection plate 30, the discharge starting auxiliary electrode 46 and the like are illustrated, the other constructions are the same as those of FIG. 8.

As described above, according to the present invention, the discharge can be triggered in a short time without complicating an apparatus.

What is claimed is:

1. A cold cathode ionization vacuum gauge comprising:
an anode;
a cathode disposed so as to form a discharge space together with the anode; and
a discharge starting auxiliary electrode disposed in the discharge space, electrically connected to at least one of the anode and the cathode, and including a carbon nanotube layer.

2. The cold cathode ionization vacuum gauge according to claim 1, wherein the discharge starting auxiliary electrode further includes a support member for supporting the carbon nanotube layer.

3. The cold cathode ionization vacuum gauge according to claim 2: wherein
the support member is a discharge starting anode auxiliary electrode plate mounted on the anode; and wherein
the carbon nanotube layer is formed on the discharge starting anode auxiliary electrode plate.

4. The cold cathode ionization vacuum gauge according to claim 3, wherein the discharge starting auxiliary electrode includes a protective member so as to cover the carbon nanotube layer formed on the discharge starting anode auxiliary electrode plate.

5. The cold cathode ionization vacuum gauge according to claim 3, wherein the discharge starting anode auxiliary electrode plate includes an opening allowing the anode to be inserted therethrough at a central portion and an elastic support claw disposed on the inner circumferential side of the opening.

6. The cold cathode ionization vacuum gauge according to claim 3: wherein the discharge starting auxiliary electrode plate includes a first electrode member having an opening allowing the anode to be inserted therethrough at a central portion and a second electrode member fixed on the outer circumferential side of the first electrode member; and wherein the carbon nanotube layer is formed only on the second electrode member.

7. The cold cathode ionization vacuum gauge according to claim 3, wherein the carbon nanotube layer is formed only on the surface of the discharge starting auxiliary electrode plate on a side where the cathode is sealed.

8. The cold cathode ionization vacuum gauge according to claim 1, further comprising a cathode auxiliary electrode protection plate that includes an opening allowing the anode to be inserted therethrough at a central portion, and is mounted on the cathode, wherein
an inside diameter of the opening of the auxiliary electrode protection plate is smaller than a diameter of the discharge starting auxiliary electrode.

9. The cold cathode ionization vacuum gauge according to claim 1, further comprising an anode auxiliary electrode protection plate to be mounted in a position on the side closer to a vacuum container connected to the cold cathode ionization vacuum gauge than in a position where the discharge starting auxiliary electrode electrically connected to the anode is mounted, wherein
a diameter of the anode auxiliary electrode protection plate is larger than that of the discharge starting auxiliary electrode.

10. The cold cathode ionization vacuum gauge according to claim 1, wherein the discharge starting auxiliary electrode is detachably mounted on the cathode.

11. The cold cathode ionization vacuum gauge according to claim 10, wherein the discharge starting auxiliary electrode includes the carbon nanotube layer in a position opposite to the anode.

12. The cold cathode ionization vacuum gauge according to claim 10, wherein the discharge starting auxiliary electrode includes an elastic support claw at an outer circumference, and which is held at the cathode by the support claw biasing the internal surface of the cathode outward.

13. The cold cathode ionization vacuum gauge according to claim 10, wherein the discharge starting auxiliary electrode includes an opening for allowing the anode to be inserted, and has a protrusion formed at the inside edge portion of the opening.

14. The cold cathode ionization vacuum gauge according to claim 10, wherein the protrusion is bent in a predetermined direction of the anode.

15. The cold cathode ionization vacuum gauge according to claim 10, wherein the discharge starting auxiliary electrode includes a first electrode member having an opening for allowing the anode to be inserted therethrough at a central portion and a second electrode member that is fixed to the outer circumferential side of the first electrode member and supported on the inside of the cathode; and wherein the carbon nanotube layer is formed only on the first electrode member.

16. The cold cathode ionization vacuum gauge according to claim 10, wherein the discharge starting auxiliary electrode includes a protective member so as to cover the portion at which the carbon nanotube layer is formed.

17. The cold cathode ionization vacuum gauge according to claim 10, further comprising an anode auxiliary electrode protection plate to be mounted in a position on the side closer to a vacuum container connected to the cold cathode ionization vacuum gauge than in a position where the discharge starting auxiliary electrode electrically connected to the cathode is mounted, wherein
a diameter of the anode auxiliary electrode protection plate is larger than that of an opening of the discharge starting auxiliary electrode.

18. A discharge starting auxiliary electrode for use in a cold cathode ionization vacuum gauge comprising a rod-like anode, a cathode provided so as to surround the anode and including a discharge space in a region between the cathode and the anode, and a magnet provided at the outer circumference of the cathode, wherein
a carbon nanotube layer is formed, and the discharge starting auxiliary electrode further comprises a support claw for detachably mounting the discharge starting auxiliary electrode on the cathode at the periphery.

19. A vacuum processing apparatus comprising a cold cathode ionization vacuum gauge according to claim 1.

20. The cold cathode ionization vacuum gauge according to claim 1: wherein
the discharge starting auxiliary electrode further includes a member having the carbon nanotube layer formed thereon; and wherein
the carbon nanotube layer is formed on the member on a side opposite to a vacuum container connected to the cold cathode ionization vacuum gauge.
